(19) United States
(12) Patent Application Publication
(10) Pub. No.: US 2011/0030525 A1
(43) Pub. Date: Feb. 10, 2011

(54) Paper punch

(76) Inventor: Chien-Chuan Huang, Chang Hua City (TW)

Correspondence Address: BACON & THOMAS, PLLC, 625 SLATERS LANE, FOURTH FLOOR, ALEXANDRIA, VA, 22314-1176, US

(21) Appl. No.: 12/461,282

(22) Filed: Aug. 6, 2009

(51) Int. Cl. B26D 5/08

(52) U.S. Cl. 83/620

(57) ABSTRACT

A paper punch includes a first arm which includes two side portions pivotably connected to two frames on a base and each side portion has a first oval hole. Two second arms are pivotably connected with the two first oval holes by two connection pins and each of the two second arm has a second oval hole. Two punch heads are connected to the two second arms respectively and movably inserted into the two frames. The two side portions of the first arm are pivotably connected to the two respective rear ends of the two frames. The two second oval holes of the two second arms are pivotably connected to the two respective front ends of the two frames. The distance between the connection pin and the first pin is reduced when the first arm is pivoted downward so as to achieve the purpose of saving energy.

### FIELD OF THE INVENTION

The present invention relates to a paper punch, and more particularly, to a paper punch with an energy-saving link unit which change the distance of arm of force to save the users' effort.

### BACKGROUND OF THE INVENTION

A conventional paper punch is shown in FIGS. 6 and 7, and generally includes an arm 51, a link unit including a first link 52 and a second link 53, a punch head 54, a frame 55 and a base 56. When a force “P” is applied to the arm 51 which is pivoted about a first pivot 511 and the arm of force “W” is the distance from the point where “P” applies to the first pivot 511. The first link 52 is then pivoted about the second pivot 521 and the arm of force “X” is the distance from the second pivot 521 to the first pivot 511. The second link 53 is then pivoted about the third pivot 531 and the arm of force “Y” is the distance from the fourth pivot 522 to the third pivot 531. The second link 53 pushes the punch head 54 downward which is pivoted about the fifth pivot 532 to punch paper stack (not shown). The arm of force “Z” is the distance from the fifth pivot 532 to the third pivot 531. When “W” and “Y” are respectively larger than “X” and “Z”, the force “P” is more efficient to punch paper sheets.

However, the distance of “X” and “Z” are fixed and cannot be adjusted so that the efficiency of operation of the paper punch is limited and the efficiency can be improved.

The present invention intends to provide a paper punch which includes an improved link unit and the distances of the arms of force of the parts can be changed so as to obtain a high punching efficiency.

### SUMMARY OF THE INVENTION

The present invention relates to a paper punch which comprises a first arm having two side portions and two first oval holes are respectively defined through the two side portions. The two side portions are pivotably connected to two frames on a base. Two second arms are pivotably connected with the two first oval holes of the two side portions of the first arm and each of the two second arm has a second oval hole. Two punch heads are connected to the two second arms and movably inserted into the two frames respectively. Each of the two frames has a front end and a rear end, the two side portions of the first arm are pivotably connected to the two respective rear ends of the two frames. The two second oval holes of the two second arms are pivotably connected to the two respective front ends of the two frames.

The primary object of the present invention is to provide a paper punch wherein the second arms can be shifted within the first oval holes in the two side portions of the first arm during operation so that the users can apply less force to punch paper sheets.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the paper punch of the present invention;

FIG. 2 is a perspective view to show the paper punch of the present invention;

FIG. 3 is a side cross sectional view of the paper punch of the present invention;

FIG. 4 is a side cross sectional view to show that the first arm is pivoted downward;

FIG. 5 is a side cross sectional view to show that the first arm is further pivoted downward;

FIG. 6 is a side cross sectional view to show a conventional paper punch, and

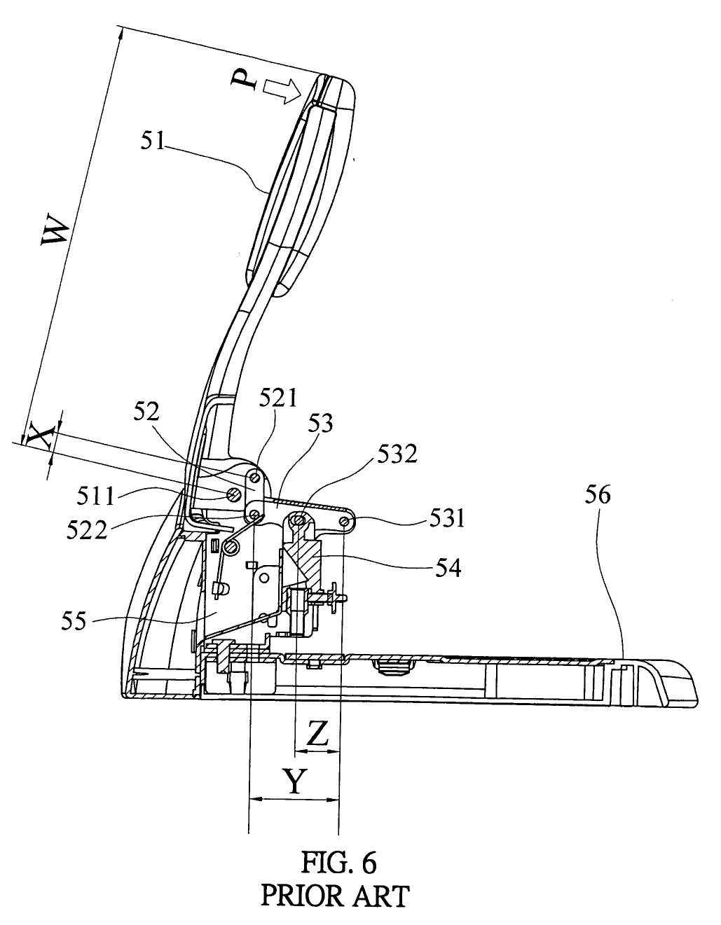

FIG. 7 is a side cross sectional view to show that the arm of the conventional paper punch is pivoted downward.

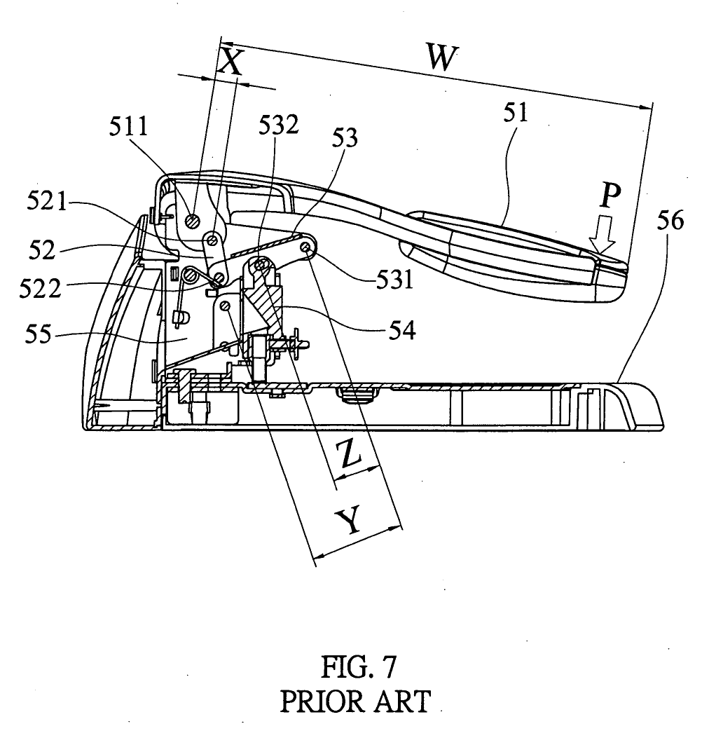

### DETAILED DESCRIPTION OF THE PREFERRED EMBODIMENT

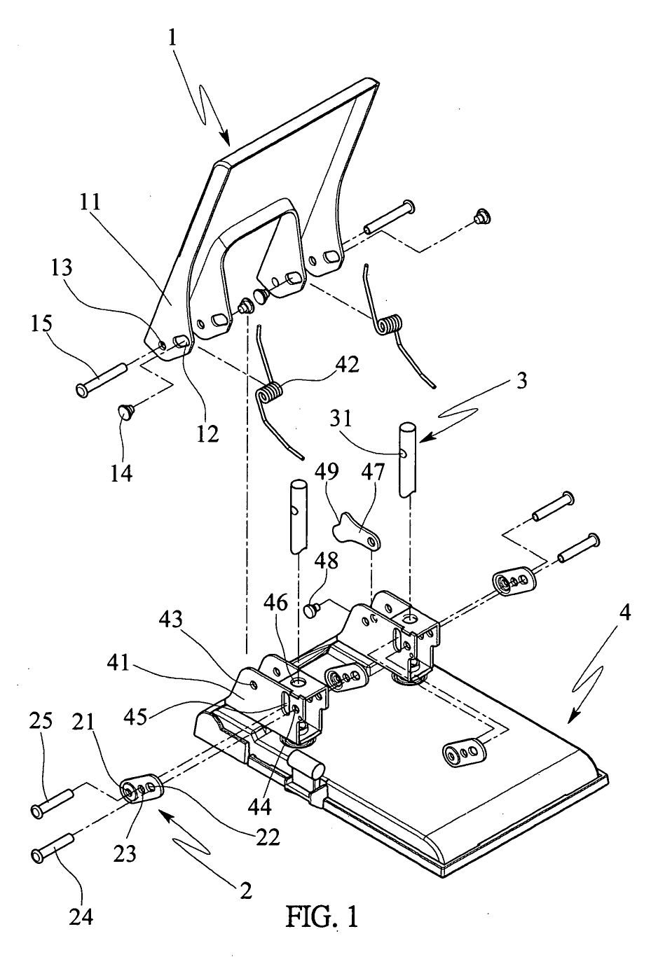

Referring to FIGS. 1 to 3, the paper punch of the present invention comprises a U-shaped first arm 1 having two side portions 11 and two first oval holes 12 and two first holes 13 are respectively defined through the two side portions 11.

Two second arms 2 are pivotably connected with the two first oval holes 12 of the two side portions 11 of the first arm 1 by extending two connection pins 14 through the two first oval holes 12 in the side portions 11 and two second holes 21 in the two second arms 2. Each of the two second arm 2 is an elongate plate and further has a second oval hole 22 and a third hole 23 which is located between the second hole 21 and the second oval hole 22.

A base 4 has two frames 41 on a top thereof and each of the two frames 41 includes two sidewalls and has a front end and a rear end. Each of the two sidewalls of each frame 41 includes a rear hole 43, a front hole 44 and a slot 45 which is located close to the front end. The two side portions 11 of the first arm 1 are pivotably connected to the two respective rear ends of the two frames 41. The two second oval holes 22 of the two second arms 2 are pivotably connected to the two respective front ends of the two frames 41. Two punch heads 3 each have a passage 31 defined transversely therethrough and are inserted into the two frames 41 via two holes 46 defined in top and bottom between the two sidewalls of each frame 41.

Two first pins 15 extend through the two respective first holes 13 of the two side portions 11, the rear holes 43 of the frames 41 and two torsion springs 42 received in the two frames 41. Two second pins 24 extend through the second oval hole 22 corresponding thereto and the front holes 44 of the two frames 41. Two third pins 25 extend through the third hole 23 corresponding thereto, the slots 45 of the two frames 41 and the passages 31 of the two punch heads 3.

A stop plate 47 is connected to one of the two frames 41 by a positioning member 48 and includes a recess 49 defined in a top thereof.

When the user applies a force “P” to the first arm 1, the first arm 1 is pivoted about the first pin 15 and the arm of force “A” is the distance from the point that “P” is applies to the first pin 15. The side portions 11 than move the connection pins 14 to pivot the second arms 2 about the second pins 24. The arm of force “B” is the distance from the connection pin 14 to the first pin 15. The arm of force “C” is the distance from the connection pin 14 to the second pin 24. The third pins 25 are activated to lower the punch heads 3 to punch paper sheets. The arm of force “D” is the distance from the third pin 25 to the second pin 24. When “A” is larger than “B” and “C” is larger than “D”, the user can apply less force to generate significant force to punch the paper sheets.

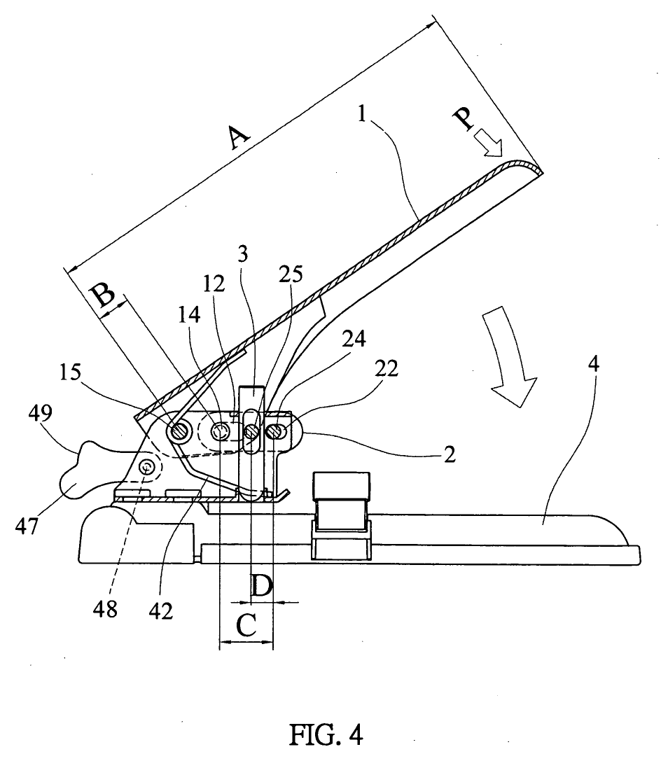

Referring to FIG. 4, when the first arm 1 is pivoted downward, the connection pins 14 are shifted from right to left in the first oval holes 12, thereby shortening the distance of “B”. The second pins 24 are shifted from right to left in the second oval holes 22, thereby shortening the distance of “D”. Accordingly, the shorter the distances of the “B” and “D”, the higher efficiency that the paper punch is obtained.

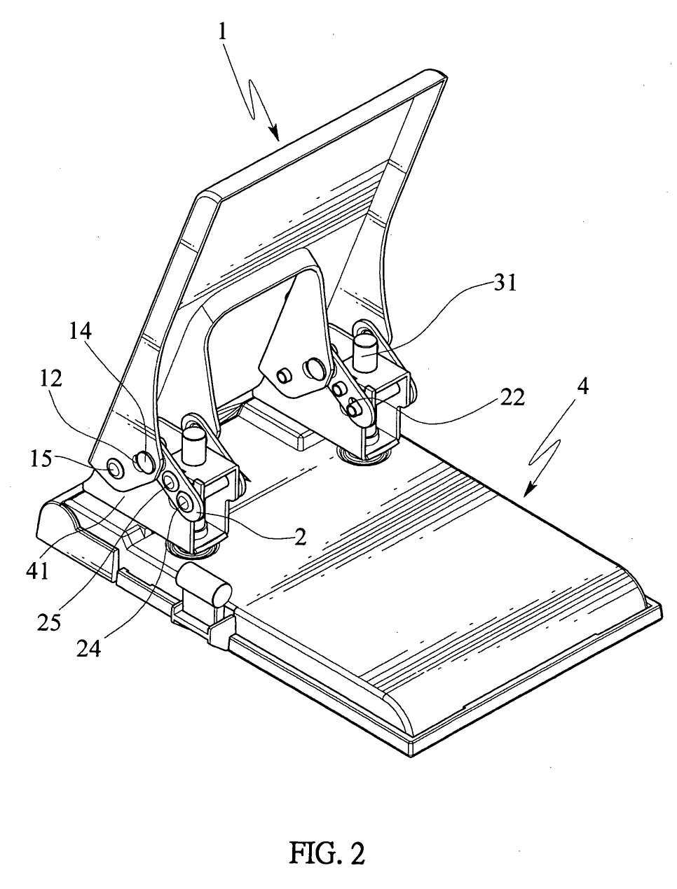

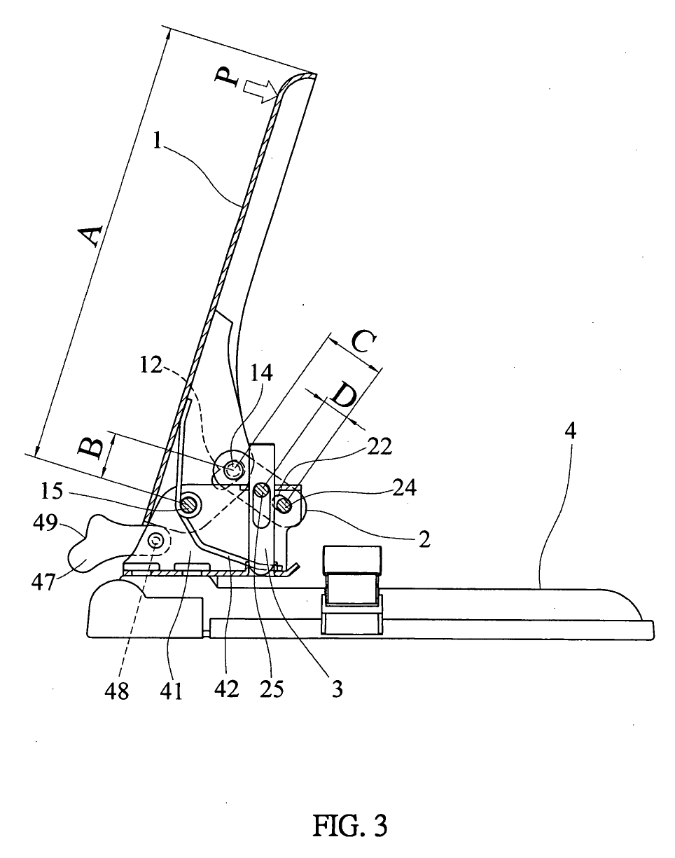

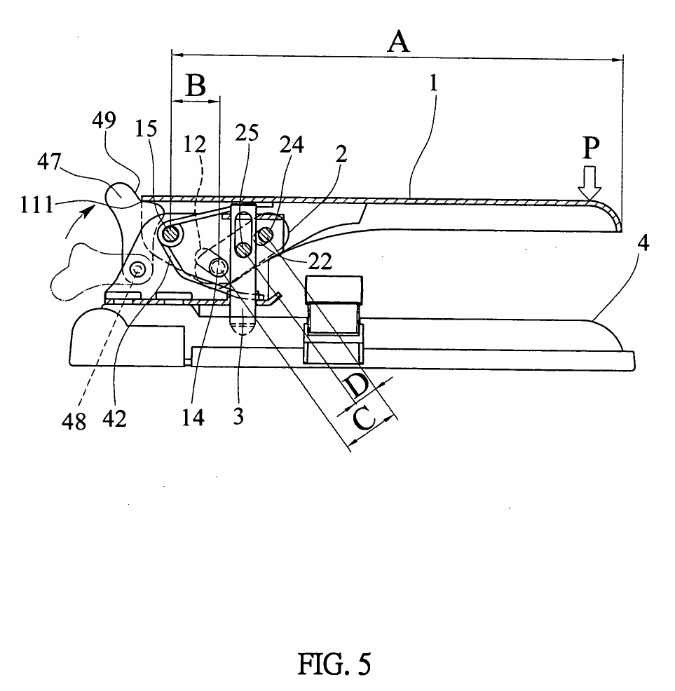

Referring to FIG. 5, by continuing pivoting the first arm 1 downward, the punch heads 3 penetrate through the paper sheets. When releasing the first arm 1, the torsion springs 42 push the first arm 1 and the second arms 2 upward, and the punch heads 3 are lifted to the status in FIGS. 2 and 3.

When the paper punch is not used, the user may pivot the first arm 1 to horizontal position and the stop plate 47 is pivoted upward so that the end 111 of the first arm 1 is stopped by the recess 49 of the stop plate 47. The first arm 1 is then positioned at the horizontal position which makes the paper punch to be compact and occupies less space.

While we have shown and described the embodiment in accordance with the present invention, it should be clear to those skilled in the art that further embodiments may be made without departing from the scope of the present invention.

What is claimed is:

1. A paper punch comprising:
a first arm having two side portions and two first oval holes respectively defined through the two side portions;
two second arms pivotably connected with the two first oval holes of the two side portions of the first arm and each of the two second arms having a second oval hole;
two punch heads connected to the two second arms respectively, and
a base having two frames and each of the two frames having a front end and a rear end, the two side portions of the first arm pivotably connected to the two respective rear ends of the two frames, the two second oval holes of the two second arms pivotably connected to the two respective front ends of the two frames, the two punch heads located within the two frames.

2. The paper punch as claimed in claim 1, wherein the two second arms are two elongate plates.

3. The paper punch as claimed in claim 1, wherein two first holes are defined through the two side portions respectively.

4. The paper punch as claimed in claim 3, wherein two first pins extend through the two respective first holes of the two side portions and two connection pins extend through the two first oval holes.

5. The paper punch as claimed in claim 4, wherein each of the two second arms includes a second hole and a third hole, the connection pin extends through the second hole corresponding thereto and the third hole is located between the second hole and the second oval hole.

6. The paper punch as claimed in claim 5, wherein two second pins extend through the second oval hole corresponding thereto and two third pins extend through the third hole corresponding thereto.

7. The paper punch as claimed in claim 6, wherein the two frames each have two rear holes and two front holes in two sidewalls thereof, each of the two first pins extends through the two rear holes of the frame corresponding thereto and each of the second pins extends through the two front holes of the frame corresponding thereto.

8. The paper punch as claimed in claim 6, wherein the two frames each have two slots in the two sidewalls thereof, two holes are defined in a top and a bottom between the two sidewalls of each frame, and a spring is received between the two sidewalls of each frame, the third pins extend through the slots of the two frames respectively, the two punch heads are movably inserted through the holes between the two sidewalls of the two frames.

9. The paper punch as claimed in claim 1, wherein each of the two punch heads has a passage defined transversely therethrough.

10. The paper punch as claimed in claim 1, wherein a stop plate is connected to one of the two frames and an end of one of the two side portions of the first arm is stopped by the stop plate.
